(19) United States
(12) Patent Application Publication
(10) Pub. No.: US 2025/0039524 A1
(43) Pub. Date: Jan. 30, 2025

(54) MULTI-TASK DEVICE COMPRISING A CAMERA AND A SINGLE SPINDLE FOR PLACING THE CAMERA IN A FOCUSSING POSITION

(71) Applicant: SETI-TEC, COLLEGIEN (FR)

(72) Inventor: Sébastien Pereira-Santo, CHARNECA DA CAPARICA (PT)

(21) Appl. No.: 18/716,228

(22) PCT Filed: Dec. 6, 2022
(86) PCT No.: PCT/EP2022/084657

§ 371 Date: Jun. 4, 2024

(30) Foreign Application Priority Data
Dec. 9, 2021 (FR) FR2113238

(51) Int. Cl. H04N 23/54; G01N 21/88; G06T 7/246; G06T 7/73; H04N 23/695

(52) U.S. Cl. CPC H04N 23/54; G01N 21/8851; G06T 7/246; G06T 7/73; H04N 23/695; G06T 2207/10016; G06T 2207/30204; G06T 2207/30244

(57) ABSTRACT

A multi-task device including: a single drive spindle movable in rotation and/or in translation along a same axis and able to cooperate individually with movable members in order to drive them in a rotation movement and/or translation movement allowing them to perform their given task; a camera having a depth of field, the camera being mounted movably between at least: a stowage position wherein it does not extend in the axis of the single spindle; an intermediate position wherein it extends in the axis of the single spindle. The spindle is able to act on the camera so as to move it into at least one focussing position wherein the surface of the structure to be worked is situated in the depth of field of the camera.

### 1. CROSS-REFERENCE TO RELATED APPLICATIONS

This Application is a Section 371 National Stage Application of International Application No. PCT/EP2022/084657, filed Dec. 6, 2022, and published as WO 2023/104826 A1 on Jun. 15, 2023, not in English, which claims priority to French Patent Application No. 2113238, filed Dec. 9, 2021, the contents of which are hereby incorporated by references in their entireties.

### 2. FIELD OF THE INVENTION

The field of the invention is that of the design and production of devices implemented in industry to perform various tasks on a structure to be worked, in particular for the aeronautical industry.

### 3. PRIOR ART

Many devices are commonly implemented to perform various tasks or operations on a structure to be worked. This may, for example, be drilling, countersinking, setting a temporary fastening, coating a rivet with mastic then setting this rivet into a hole drilled in a structure or any other operation.

Movable devices have been developed to make it possible to perform tasks on complex structures such as, for example, aircraft.

These devices particularly include those of the type comprising a tooling placed at the end of a robot arm to be manipulated and moved in relation to the structure to be worked, the device comprising securing means, such as for example suction cups, making it possible to make the tool secure with the structure to be worked in order to make it take up the forces due to the accomplishment of the task to relieve the robot arm.

Some devices of this type, called multi-task devices, are likely to be fitted with a plurality of functional modules each dedicated to performing a particular task.

Such a device comprises a single output spindle likely to be driven in rotation and/or in translation along the same axis via drive and control means.

This single spindle may be brought to cooperate alternately with the various fitted modules such as to make it possible to perform a task for which they are dedicated.

The patent applications PCT/EP2020/069158, PCT/EP2020/069159, PCT/EP2020/069160, PCT/EP2020/069161, PCT/EP2020/069162, filed by the Applicant, describe multi-task devices.

In order to be able to perform the various operations at exact locations of the structure to be worked, it is necessary to be able to identify the position in space of the device in relation to the structure, and particularly the orthogonality of the axis of the output spindle in relation to the surface of the structure to be worked as well as the location of the intersection of the axis of the spindle with the surface of the structure to be worked relative to a mark on this surface, and to adjust these geometric criteria relative to the production requirement.

It may also be necessary to have means making it possible, after an operation has been performed, to control the quality thereof.

The aim of the present invention is particularly to improve the techniques for adjusting the position of the multi-task device relative to the structure to be worked and/or to make it possible to control an operation after it has been performed.

### 4. DESCRIPTION OF THE INVENTION

For this purpose, the invention proposes a multi-task device comprising:
a frame;
means for fastening said frame to motorised handling means able to move at least partially said device in space in relation to a structure to be worked;
means for positioning and/or securing said device to said structure to be worked, the distance between said device and the surface of said structure to be worked being able to vary between an approach position and a docking position;
at least two functional modules, each of said functional modules comprising at least one movable member able to make it possible to perform a given task on said structure to be worked;
a single drive spindle movable in rotation and/or in translation along the same axis and able to cooperate individually with said movable members in order to drive them in a rotation movement and/or translation movement allowing them to perform their given task;
a camera having a depth of field, said camera being mounted movably between at least:
one stowage position wherein it does not extend in the axis of said single spindle;
one intermediate position wherein it extends in the axis of said single spindle;
   said spindle being able to act on said camera so as to move it into at least one focussing position wherein said surface of said structure to be worked is situated in the depth of field of the camera.

Thus, according to this aspect of the invention, the single spindle of a multi-task device fitted with a camera can be used to move the camera in order to make it focus.

Thus, the invention makes it possible to use a camera without autofocus for example to identify a multi-task device in space in relation to a structure to be worked and/or to control the quality of a task performed.

The technology without autofocus is significantly more robust and takes up little space. The implementation of a camera of this type thus makes it possible to procure a multi-task device, equipped with a camera, that is particularly robust and compact.

According to a possible alternative embodiment, a device according to the invention comprises means for coupling said single spindle with said camera, said means for coupling making it possible to connect in translation said single spindle with said camera in such a way that said camera is likely to be moved between said intermediate position and said at least one focussing position along said axis.

Such coupling means may be implemented to perform a coupling step.

According to a possible alternative embodiment, said camera is mounted movable in translation along an axis orthogonal to said axis of movement of said single spindle between said stowage position and said intermediate position.

According to a possible alternative embodiment, a multi-task device according to the invention comprises means for guiding and driving in translation said camera between its stowage and intermediate positions.

Such means may be used to perform a step of guiding and driving in translation said camera between its stowage and intermediate positions.

According to a possible alternative embodiment, said means for guiding in translation comprise a camera support plate connected to the frame by a slide connection of axis orthogonal to the axis of said single spindle.

This makes it possible to move simply but with precision and robustness the camera.

According to one possible feature, said plate is penetrated with a hole allowing the passage of said single spindle when the camera is in stowage position.

According to one possible feature, a multi-task device according to the invention comprises means for controlling said camera and analysing images captured by said camera.

Such means may be used to perform a step of controlling said camera and a step of analysing images captured by said camera.

### Detecting an Undesired Movement of the Device

According to a possible alternative embodiment, said means for controlling and analysing are able to detect, particularly during a detection step, when a device according to the invention is used to implement a method for performing at least one task, an undesired movement of said device in relation to said surface when said device is being secured to said surface by said securing means.

According to a possible alternative embodiment, the undesired movement of said device in relation to said surface likely to be detected by said means for controlling and analysing is a movement essentially parallel to said surface.

According to a possible alternative embodiment, said means for controlling and analysing are able to identify singular points at the surface of said structure to be worked and to monitor their movement in successive images captured by said camera and deduce therefrom an undesired movement of said device in relation to said surface of said structure to be worked.

This may be implemented for performing a step of identifying singular points at the surface of said structure to be worked and a step of monitoring their movement in successive images captured by said camera and a step of deducing an undesired movement of said device in relation to said surface of said structure to be worked.

### Detecting the Position of Said Multi-Task Device Relative to Said Marking Elements

According to one possible feature said means for controlling and analysing are able to detect marking elements arranged on said surface and to deduce, from their position in images captured by said camera, the position of said multi-task device relative to said marking elements.

This may be implemented to perform a step of detecting marking elements arranged on said surface and a step of deducing, from their position in images captured by said camera, the position of said multi-task device relative to said marking elements.

According to one possible feature, said functional modules belong to the group comprising at least:
the drilling modules;
the modules for setting rivets coated or not with mastic;
the modules for setting temporary fastenings.

### Controlling the Aspect of a Hole or of a Countersink

According to one possible feature, said means for controlling and analysing are able to control the aspect of a hole or of a countersink made by means of a drilling module and to verify its conformity to pre-established visual quality criteria.

This may be implemented in order to perform a step of controlling the aspect of a hole or of a countersink.

### Controlling the Depositing of Mastic

According to one possible feature, said means for controlling and analysing are able to control the aspect of a corolla of mastic protruding laterally from the head of a rivet set by means of a module for setting the rivet and to verify its correct continuity around the head of the rivet certifying its conformity.

This may be implemented in order to perform a step of controlling a corolla of mastic protruding laterally from the head of a countersink.

### Projecting on Said Surface a Predetermined Pattern

According to a possible alternative embodiment, a multi-task device according to the invention comprises means for projecting on said surface a predetermined pattern, said means for controlling and analysing means being able to capture and analyse said pattern and deducing therefrom an absence of normality of said single spindle in relation to said surface.

This may be implemented to perform a step of projecting on said surface a predetermined pattern and a step of controlling the normality of said single spindle in relation to said surface.

According to a possible alternative embodiment, a multi-task device according to the invention comprises means for securing said device to motorised handling means able to move at least partially said multi-task device in space in relation to said surface between at least one approach position wherein said device is distant from said surface and a docking position wherein said device is pressed against said surface.

This may be used to perform a step of moving said multi-task device in space in relation to said surface between at least one approach position wherein said device is distant from said surface and a docking position wherein said device is pressing against said surface.

According to a possible alternative embodiment, said means for controlling and analysing are able, when said device is in said docking position, to control the aspect of a hole or of a countersink or the aspect of a corolla of mastic protruding laterally from the head of a rivet or the undesired movement of said device in relation to said surface.

According to a possible feature, said means for controlling and analysing are able, when said device is in said approach position, to detect marking elements arranged on said surface and to deduce from their position in images captured by said camera, the position of the multi-task device relative to these marking elements or to detect an absence of normality of said single spindle in relation to said surface.

The invention also relates to a method for performing a task by means of a multi-task device according to any one of the alternative embodiments hereinabove.

Such a method comprises a step of moving said camera, by means of said spindle, into at least one focussing position wherein said surface of said structure to be worked is situated in the field of depth of said camera.

### 5. DESCRIPTION OF THE FIGURES

Other features and advantages of the invention will become apparent upon reading the following description of particular embodiments, given by way of simple illustrative and non-limiting example, and the appended figures, wherein:

FIG. 1 illustrates a perspective view of one example of multi-task device according to the invention;

FIG. 2 illustrates a partial sectional view according to a plane passing through the axis of the spindle of the device of FIG. 1 with the camera in stowage position;

FIG. 3 illustrates a partial sectional view according to a plane passing through the axis of the spindle of the device of FIG. 1 with the camera in intermediate position;

FIG. 4 illustrates a partial sectional view according to a plane orthogonal to the axis of the spindle of the device of FIG. 1 with the camera in stowage position;

FIG. 5 illustrates a partial perspective view of the device of FIG. 1.

### 6. DESCRIPTION OF PARTICULAR EMBODIMENTS

### 6.1. Architecture

### Means for Fastening to Handling Means

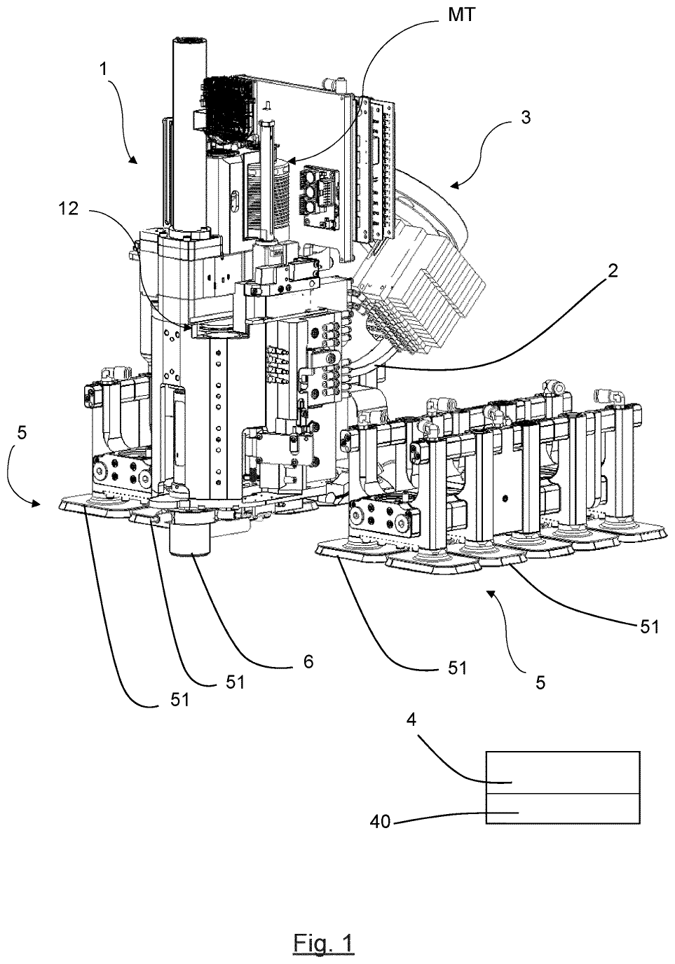

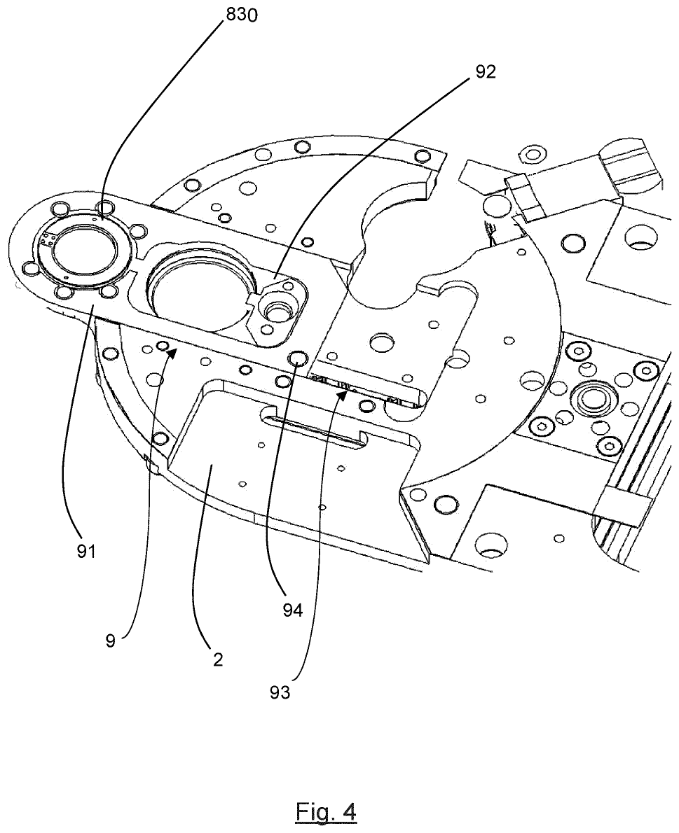

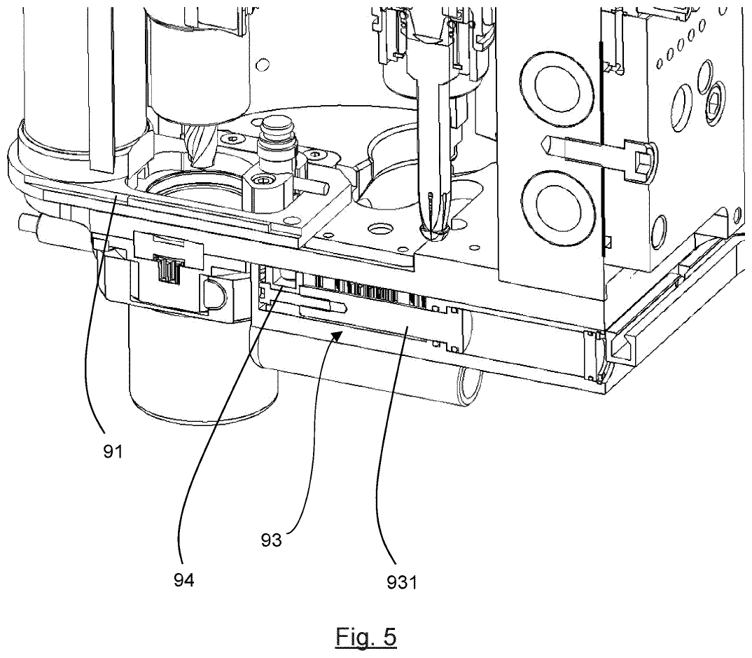

In relation with FIGS. 1 to 5 an example of a multi-task device according to the invention is described.

As shown in these figures, such a multi-task device 1 comprises a frame 2.

This frame 2 is equipped with means for fastening 3 to a motorised handling device (not shown) to which it is intended to be secured in such a way as to be able to be moved at least partially in relation to a structure to be worked (not shown).

These motorised handling means belong to the group particularly comprising:
the robot arms;
the walking robots for example according to the principle described in the patent document FR-B1-2 809 034;
the digital grids for example according to the principles described in the patent document WOA-2-200349899.

Such fastening means 3 are known per se and are therefore not described. They may for example comprise a system of the plate type and bolts, quick securing means of the clamp type, a clamp or cam system, etc.

The motorised handling means are able to move at least partially (particularly when the controller is fixed) the multi-task device in space in relation to the surface of the structure to be worked between at least one approach position wherein the device is close to the surface while being distant from it and a docking position wherein the device is pressed against the surface, for example in view of being secured thereto if securing means are implemented. They may also place the multi-task device in a stowage position when it is not used to perform an operation.

### Single Output Spindle

The device comprises a single drive spindle 7 movable in rotation and/or in translation along the same axis.

The device also comprises motor and transmission means MT to make it possible to drive the spindle in a rotation movement and/or translation movement along its longitudinal axis. These motor and transmission means are known per se and are not described in more detail here.

### Controller

The device conventionally comprises a controller 4 comprising the control and power electronics making it possible to control and power the device.

This controller 4 is preferably contained in a box distant from the frame 2 and fixedly stored on site.

The controller 4, or at the very least some of its components, could however be fitted on the frame 2.

### Means for Securing to a Structure to Be Worked (Optional)

The device may optionally, but preferably, comprise means for securing 5 to the structure to be worked.

These securing means may be of various types.

They may for example comprise suction cups 51 secured to the frame 2 and able to be connected to vacuum means such as for example a vacuum pump to improve the securing to the surface of the structure to be worked. These suction cups may be assembled in groups to form suction pads.

When no means for securing to the structure to be worked is implemented, the handling device may not only consist of a means for positioning the frame in relation to the structure to be worked but also a means for immobilising it in position in relation to the structure to be worked.

### Pressing Element (Optional)

The device may optionally comprise a pressing element 6 of tubular shape mounted movable in translation in relation to the frame 2 along the axis of movement of the spindle 51 and in the extension thereof.

The pressing element is a hollow tube for allowing the passage of the spindle and of the camera.

Such a pressing element 6 can for example be used during a drilling operation to exert a compressive force on the structure to be drilled, particularly to ensure the contact between the plates of a stack and to prevent the formation of burrs between these plates during drilling.

### Functional Modules

The device is likely to be fitted with a plurality of functional modules MF.

Each of these functional modules MF makes it possible to perform a particular task such as for example a drilling and/or countersinking operation, a rivet setting operation, an operation of setting a temporary fastening (for example a clip), a depositing (or coating) operation on a fastening element (a rivet or a screw) of a bead of sealing mastic. Other functions could be considered such as screwing.

The functional modules belong for example to the group comprising at least:
the drilling and/or countersinking modules;
the modules for setting rivets coated or not with mastic;
the modules for setting temporary fastenings.

A temporary fastening used in the aeronautical industry is a mechanical member that makes it possible to clamp at least two walls, against one another, in the aim of performing production operations necessary for a final assembly of these walls, such as counterdrilling or the setting of screws or rivets.

By definition, these temporary fastenings are removed as and when the screws or rivets ensure their function of assembling the walls.

The temporary fastenings are placed in holes made in the walls after the initial relative positioning of these walls.

The temporary fastenings only require having access on one side of one of the walls.

Such functional modules are particularly described in the patent documents PCT/EP2020/069158, PCT/EP2020/069159, PCT/EP2020/069160, PCT/EP2020/069161, PCT/EP2020/069162, filed by the Applicant.

The device comprises means 12 making it possible to place the various fitted modules in alignment with the spindle 7 in order to perform a task. These means may for example comprise a carousel, a cartridge belt or other.

### Camera Functional Module

The multi-task device comprises a camera module 8.

The camera module 8 comprises an outer tubular element 81 and an inner tubular element 82 mounted movable in translation within the outer tubular element 81. The inner tubular element 82 consists of a movable member of the camera module.

The inner tubular element 82 has an end 821 oriented on the side of the spindle 7 and an opposite end 822 carrying a camera 83.

The camera 83 is a camera without autofocus and having a field of depth. This field of depth is delimited by two sharpness planes parallel to and distant from one another located in the extension of the lens of the camera. The images captured by the camera of objects located between these two sharpness planes are sharp.

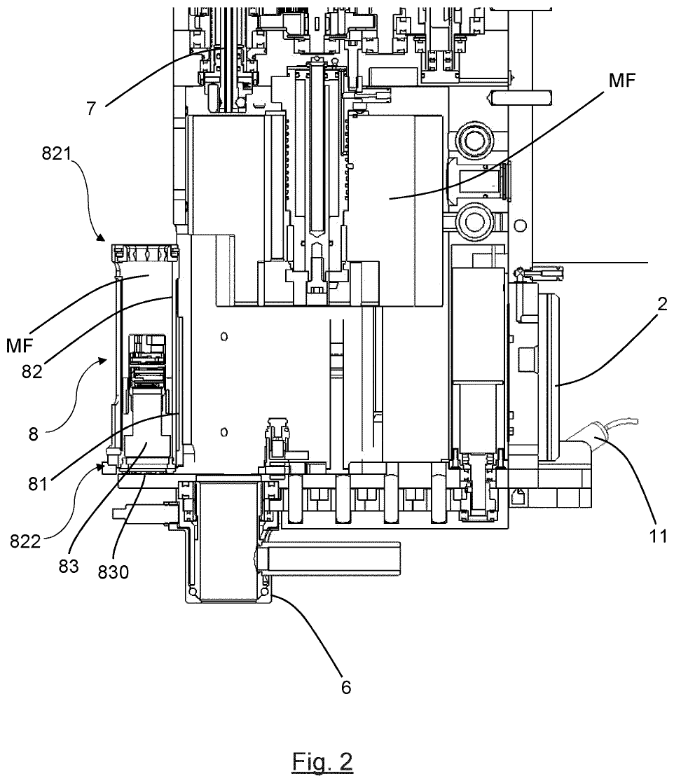

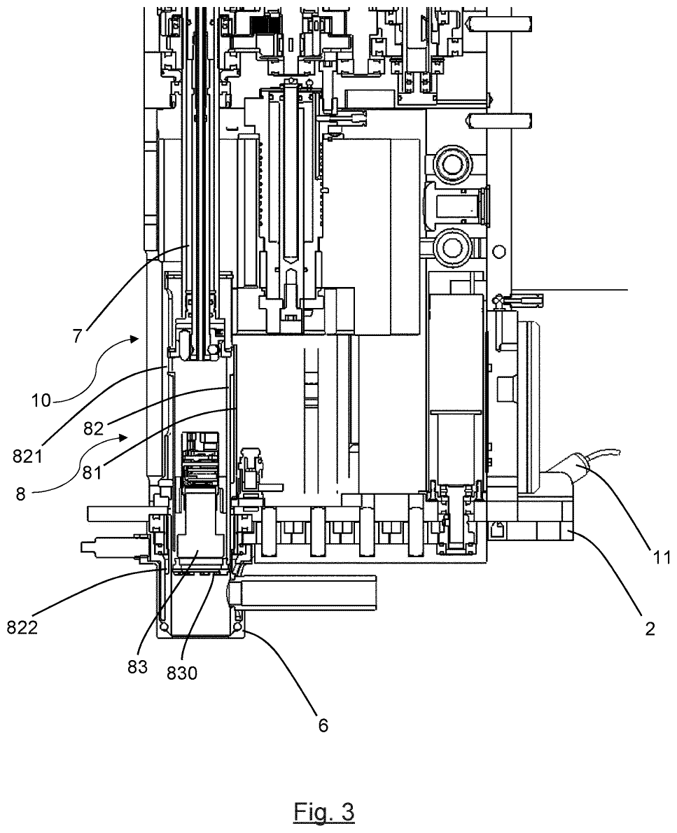

The camera 83 is mounted movably between at least:
one stowage position (see FIG. 2) wherein it does not extend in the axis of the single spindle 7;
one intermediate position (see FIG. 3) wherein it extends in the axis of the single spindle 7.

In this embodiment, the camera 83 is mounted movable in translation along an axis orthogonal to the axis of movement of the single spindle 7 between the stowage position and the intermediate position. In the stowage position, the camera is then situated laterally offset in relation to the axis of the spindle.

For this purpose, the multi-task device comprises means for guiding and driving in translation 9 the camera 83 between its stowage and intermediate positions.

The means for guiding and driving in translation 9 the camera comprise a camera support plate 91 connected to the frame 2 by a slide connection of axis orthogonal to the axis of the single spindle 7.

The outer tubular element 81 is connected by a flush-mounted connection to the camera support plate 91.

The plate 91 is penetrated with a hole 92 allowing the passage of the single spindle 7 when the camera 83 is in stowage position.

The means for guiding and driving in translation 9 comprise an actuator. In this embodiment, the actuator is a cylinder 93. The plate 91 is connected by a pin 94 at the end of the rod 931 of the cylinder 93 that may be actuated to move the plate in one direction or in the other. This cylinder 93 thus makes it possible to move the camera 83 between its stowage and intermediate positions.

The camera 83 is mounted movable in translation along the axis of the spindle 7 between at least:
the intermediate position, and
one focussing position wherein the surface of the structure to be worked is situated in the field of depth of the camera.

The spindle 7 is able to act on the camera 83 so as to move it between its intermediate and focussing positions. For this purpose, the device comprises coupling means 10 to connect in translation the spindle 7 and the camera 83 along the axis of the spindle.

The inner tubular element 82 has an end 821 oriented towards the spindle 7. This end 821 comprises first coupling means of shape complementary to the second coupling means placed at the end of the spindle 7. These coupling means may for example be of the ball expander type or other.

These first and second coupling means make it possible to connect in translation the single spindle 7 and the inner tubular element 82 in such a way that the spindle 7 can drive along its axis the inner tubular element 82 in translation in the outer tubular element 81. In doing so, the spindle moves the camera 83 carried by the inner tubular element 82.

Such coupling means are particularly described in the patent documents PCT/EP2020/069158, PCT/EP2020/069159, PCT/EP2020/069160, PCT/EP2020/069161, PCT/EP2020/069162, filed by the Applicant.

The end of the camera may be encircled by an LED strip 830.

### Means for Controlling the Camera and for Analysing Images Captured by the Camera

The device comprises means 40 for controlling the camera 83 and for analysing images captured by the camera 83. Such control and analysis means 40 are known per se by the person skilled in the art and therefore are not described in detail. Within the scope of the present invention, these means are nevertheless configured to fulfil certain functions that are described in more detail hereinafter.

### Determining and Controlling the Position of the Device in Relation to the Structure to Be Worked, Particularly the Correct Location of the Intersection of the Axis of the Spindle With the Surface Relative to a Mark on the Surface

In order to perform a task on the structure to be worked, the multi-task device must be positioned beforehand in relation to the structure to be worked at the exact location where the task must be performed.

The surface of the structure to be worked may have visual marks, made in such a way as to identify drilling locations, such as paint lines or other, templates, marker holes, etc. These marks constitute marking elements.

In this case, the control and analysis means 40 are able, when the device is in the approach position, to detect the presence of such marking elements at the surface of the structure to be worked, to analyse their position in images successively captured by the camera, and to deduce therefrom the position of the multi-task device relative to the marking elements and therefore to the structure to be worked.

The relative position of the device relative to the structure to be worked is thus taken into account to control the handling means in order to suitably place the multi-task device in relation to the structure to be worked.

More precisely, in order to perform an operation with precision, it is desired to suitably place the axis of the spindle relative to the marking elements. The control and analysis means therefore not only make it possible to deduce the position of the multi-task device relative to the structure to be worked but also to more particularly identify the position of the axis of the spindle in relation to the structure to be worked. If this position is not correct and has an unacceptable deviation in relation to the desired position, the control means control the handling means to correct this location by moving the device in a direction parallel to the surface until the axis of the spindle is suitably positioned in relation to the structure to be worked.

### Detecting an Undesired Movement of the Device in Relation to the Structure to Be Worked

In order to secure to a structure to be worked a device according to the invention comprising suction cups 51, the device is approached from the surface of the structure to be worked then the suction cups 51 are applied against this surface before creating the vacuum therein. In the case where a pressing element 6 is implemented, the pressing element 6 is subsequently pressed against the surface of the structure to be worked. Thus securing the device to the structure to be worked is completed. The aim of this securing is to precisely maintain the position of the device in relation to the structure to be worked.

During this securing phase, and in particular during the creation of a vacuum of the suction cups 51 and the application of the pressing element 6 against the surface of the structure to be worked, for accuracy and quality reasons, the device should therefore remain immobile in relation to the structure to be worked. In this drawing, the control and analysis means 40 are able to detect an undesired movement of the device in relation to the surface of the structure to be worked when the device is being secured to the surface and/or positioned in relation to the surface of the structure to be worked by the securing and/or positioning means.

Preferably, the control and analysis means 40 are able to detect an undesired movement of the device essentially parallel to the surface of the structure to be worked.

The surface of the structure to be worked may have certain visual heterogeneities such as asperities, stains, the frame of the material or other. These involuntary visual heterogeneities constitute singular points at the surface of the structure to be worked.

According to a particular embodiment, the control and analysis means 40 are able to identify such singular points at the surface of the structure to be worked and to monitor their movement in successive images captured by the camera 83 and deduce therefrom any undesired movement of the device in relation to the surface of the structure to be worked. In other terms, the control means 40 control the camera 83 such that it successively captures images of the surface of the structure to be worked during the securing of the device to the structure to be worked. The analysis means 40 are capable of comparing the successive images captured during the securing, of detecting or not detecting therein movements of singular points and of deducing therefrom if, during the securing of the device, it moves or does not move in relation to the structure to be worked.

Alternatively or additionally, the marking elements located at the surface of the structure to be worked may also be used to detect any undesired movement of the device in relation to the surface during its securing to the structure to be worked.

In these two alternative embodiments, and when the device does not comprise means for securing to the structure to be worked but only position means, the control and analysis means 40 may nevertheless detect any undesired movement of the device in relation to the structure to be worked particularly when a pressing element is applied against the surface and/or when performing an operation.

### Controlling the Aspect of a Hole or of a Countersink

In one embodiment, the control and analysis means 40 are able to control the aspect of a hole or of a countersink made by means of a drilling module and to verify its conformity in relation with pre-established visual quality criteria.

In other terms, after a drilling and/or countersinking operation has been performed, the control means 40 control the camera 83 such that it captures at least one image of the hole and/or of the countersink made in the structure to be worked. The analysis means 40 are capable of comparing this at least one image with at least one reference image representative of a hole and/or countersinking having an aspect corresponding to an expected level of quality, and of deducing therefrom if the hole and/or countersinking made are compliant. In order to control the aspect of a hole and/or countersinking on a plurality of levels, the control means may be able to control the movement of the camera along the axis of the single spindle to move its sharpness plane at least partially along the axis of the hole.

### Controlling the Aspect of a Corolla of Mastic Overflowing the Head of a Rivet

A device according to the invention may be implemented to perform the setting of a rivet in a hole arranged in the structure to be worked. A rivet is generally coated with a sealing mastic before being set. Coating may for example consist in depositing a helical bead or parallel beads of mastic on the body of the rivet and a corolla of mastic at the junction between the body and the head of the rivet.

Thus, according to one embodiment, the control and analysis means 40 are able to control the aspect of a corolla of mastic protruding laterally from the head of a rivet set by means of a module for setting the rivet and to verify its correct continuity around the head of the rivet certifying its conformity.

In other terms, after an operation of setting a coated rivet with at least one corolla of mastic has been performed, the control means 40 control the camera 83 such that it captures at least one image of the head of the rivet set in the structure to be worked. The analysis means are capable of comparing this at least one image with at least one reference image representative of a corolla suitably protruding uniformly and continuously from the head of a rivet, and of deducing therefrom if the sealing at the head of the rivet is or is not compliant.

### Controlling the Orthogonality of the Spindle Relative to the Structure to Be Worked

In order to optimally perform the various tasks that can be performed with a device according to the invention, it is preferable to be able to control, prior to performing a task, that the spindle is indeed orthogonal to the surface of the structure to be worked.

Thus, in one embodiment, the device comprises means for controlling the orthogonality of the spindle relative to the surface of the structure to be worked.

The means for controlling the orthogonality preferably comprise means for projecting on the surface a predetermined pattern. Preferably, these projection means comprise two or three lasers 11, secured to the frame 2, and able to project their radius on the structure in the area of the hole to be made.

The control and analysis means 40 are able to capture at least one image of the pattern projected by the projection means at the surface of the structure to be worked and analyse the pattern in order to deduce therefrom if applicable an absence of normality of the single spindle 7 in relation to the surface.

In the case where an orthogonality defect is detected, the controller 40 of the device controls the handling means to correct the orthogonality until it is obtained that the axis of the spindle 7 is orthogonal to the surface of the structure to be worked.

### 6.2. Operation

In order to perform a task on a structure to be worked, the handling means are firstly implemented to move the multi-task device to the location of the structure where the task must be performed.

The multi-task device is placed in its approach position wherein it extends at a certain distance from the surface of the structure to be treated.

The camera is moved into its intermediate position and coupled to the spindle.

The spindle 17 is moved along its axis in such a way as to place the camera in its focussing position by moving the inner tubular element 82.

For the spindle to place the camera in a suitable focussing position, the control means must calculate the movement that the spindle must communicate to the inner tubular element 82 supporting the camera from its intermediate position.

For this purpose, the control means take into account:
the distance between the sharpness plane of the camera and a reference surface of the inner tubular element 82 in retracted position. This distance is predetermined and depends on the camera and on its integration into the module.
the distance between the surface of the structure and the same reference surface of the tubular element 82 when the inner tubular element 82 is in retracted position. This distance may be variable depending on whether the effector is in approach position or if it is docked on the structure or also if the image having to be captured is on the surface or in a hole.

Consequently, the means for controlling the effector calculate the movement to be communicated to the module as being the difference between the two preceding distances,

The control and analysis means 40 use the camera 83 to capture images of the surface to be worked and to detect in these images the marking elements for controlling the handling means in order to ensure a suitable positioning of the device in relation to the structure to be worked, and in particular to suitably place the axis of the spindle in relation to the structure to be worked.

The lasers 11 subsequently project on the surface of the structure to be worked a predetermined pattern and the control and analysis means 40 control the camera 83 so that it captures at least one image of the projected pattern. The analysis means analyse the image(s) captured by the camera and deduce therefrom if the axis of the spindle is orthogonal to the surface. In the opposite case, the control means act on the handling means to correct the orthogonality of the spindle until its axis is orthogonal to the surface.

Once the position of the device (in particular of the axis of the spindle) and the orthogonality of the spindle are correct, the device is moved into its docking position in a direction normal to the surface.

The securing means, for example the suction cups, are if applicable activated to secure the frame to the structure to be worked.

During the securing, the pressing element is if applicable pressed against the surface of the structure to be worked.

In order to make it possible to control the absence of sliding of the effector in relation to the surface during the securing, the camera module is moved by the spindle into a new focussing position on the surface.

During this securing, the control and analysis means verify if the device moves in relation to the surface of the structure to be worked by determining, from a comparison of the images captured by the camera during the securing, if singular points of the surface to be worked move from one image to another. If so, the securing means are deactivated and the handling means are implemented to correct the position of the device before once again performing the securing of the device to the structure to be worked.

If no securing means is implemented, the maintaining in position of the frame in relation to the surface will be performed by the handling means. In this case, the control and analysis means will check when performing each task if the device slides in relation to the structure to be worked.

When the device is suitably positioned and/or secured, the camera is placed in its intermediate position before being uncoupled from the spindle then placed in its stowage position.

The module corresponding to the operation that it is desired to perform is placed in the axis of the spindle then coupled to it.

The spindle is subsequently moved in order to perform the desired operation, for example drilling and/or countersinking, setting a coated or non-coated rivet, setting a temporary fastening, etc.

Once the operation has been performed, the spindle is uncoupled from the functional module then the functional module is moved so as to no longer be located in the axis of the spindle.

The camera is moved into its intermediate position before being coupled with the spindle.

The control means may subsequently move the camera into its focussing position and the analysis means control the quality of the operation performed such as for example the quality of a hole and/or of a countersink or the quality of the sealing at the head of a rivet. The information according to which the operation performed is compliant or not is recorded in the controller.

Other tasks may subsequently be performed in the same location (for example the insertion of a rivet into a hole) or in another location of the structure to be worked.

An exemplary embodiment of the present invention provides an effective solution to at least some of these various problems.

In particular, least one embodiment provides a technique making it possible to easily identify and adjust the relative position of a multi-task device in relation to the surface of a structure to be worked.

In particular, at least one embodiment provides such a technique that makes it possible to control and adjust the orthogonality of the spindle in relation to the surface of the structure to be worked.

An exemplary embodiment provides such a technique that makes it possible to control and adjust the location of the intersection of the axis of the spindle with the surface of the structure to be worked relative to a mark present on this surface.

An exemplary embodiment provides such a technique that makes it possible to control the quality of an operation performed.

An exemplary embodiment provides such a technique that can be implemented in a compact way.

An exemplary embodiment provides such a technique that is reliable and/or robust.

Although the present disclosure has been described with reference to one or more examples, workers skilled in the art will recognize that changes may be made in form and detail without departing from the scope of the disclosure and/or the appended claims.

1. A multi-task device comprising:
a frame;
a fastener for fastening said frame to a motorised handler able to move at least partially said device in space in relation to a structure to be worked;
a positioning/securing element for positioning and/or securing said device to said structure to be worked, a distance between said device and the surface of said structure to be worked being able to vary between an approach position and a docking position;
at least two functional modules, each of said functional modules comprising at least one movable member able to make it possible to perform a given task on said structure to be worked;
a single drive spindle movable in rotation and/or in translation along a same axis and able to cooperate individually with said movable members in order to drive said movable members in a rotation movement and/or translation movement allowing said movable members to perform their given task;
a camera having a depth of field, said camera being mounted movably between at least:
a stowage position wherein the camera does not extend in the axis of said single spindle;
an intermediate position wherein the camera extends in the axis of said single spindle;
said spindle being able to act on said camera so as to move the camera into at least one focussing position wherein said surface of said structure to be worked is situated in the depth of field of the camera.

2. The multi-task device according to claim 1 comprising a coupler for coupling said single spindle with said camera, said coupler making it possible to connect in translation said single spindle with said camera in such a way that said camera is likely to be moved between said intermediate position and said at least one focussing position along said axis.

3. The multi-task device according to claim 1 wherein said camera is mounted movable in translation along an axis orthogonal to said axis of movement of said single spindle between said stowage position and said intermediate position.

4. The multi-task device according to claim 3 comprising means for guiding and driving in translation said camera between its stowage and intermediate positions.

5. The multi-task device according to claim 4, wherein said means for guiding in translation comprise a camera support plate connected to the frame by a slide connection of axis orthogonal to the axis of said single spindle.

6. The multi-task device according to claim 5 wherein said plate is penetrated with a hole allowing passage of said single spindle when the camera is in stowage position.

7. The multi-task device according to any claim 1 comprising means for controlling said camera and for analysing images captured by said camera.

8. The multi-task device according to claim 7 wherein said means for controlling and analysing are configured to detect an undesired movement of said device in relation to said surface when said device is being secured to said surface by said securing element.

9. The multi-task device according to claim 8 wherein the undesired movement of said device in relation to said surface likely to be detected by said means for controlling and analysing is a movement essentially parallel to said surface.

10. The multi-task device according to claim 8 wherein said means for controlling and analysing are configured to identify singular points at the surface of said structure to be worked and to monitor their movement in successive images captured by said camera and deduce therefrom an undesired movement of said device in relation to said surface of said structure to be worked.

11. The multi-task device according to claim 7 wherein said means for controlling and analysing are configured to detect marking elements arranged on said surface and to deduce, from their position in images captured by said camera, a position of said multi-task device relative to said marking elements.

12. The multi-task device according to claim 1 wherein said functional modules belong to the group consisting of:
drilling modules;
modules for setting rivets coated or not with mastic;
modules for setting temporary fastenings.

13. The multi-task device according to claim 11 wherein said means for controlling and analysing are configured to control an aspect of a hole or of a countersink made by a drilling module and to verify conformity to pre-established visual quality criteria.

14. The multi-task device according to claim 11 wherein said means for controlling and analysing are configured to control an aspect of a corolla of mastic protruding laterally from a head of a rivet set by a module for setting the rivet and to verify correct continuity around the head of the rivet certifying its conformity.

15. The multi-task device according to claim 1 comprising a projector for projecting on said surface a predetermined pattern, said means for controlling and analysing being configured to capture and analyse said pattern and deducing therefrom an absence of normality of said single spindle in relation to said surface.

16. The multi-task device according to claim 1 wherein the fastener is configured to move at least partially said multi-task device in space in relation to said surface between the approach position wherein said device is distant from said surface and the docking position wherein said device is pressed against said surface.

17. The multi-task device according to claim 16, wherein said means for controlling and analysing are configured to, when said device is in said docking position, control an aspect of a hole or of a countersink or an aspect of a corolla of mastic protruding laterally from a head of a rivet or an undesired movement of said device in relation to said surface.

18. The multi-task device according to claim 16 wherein said means for controlling and analysing are configured to, when said device is in said approach position, detect marking elements arranged on said surface and to deduce from their position in images captured by said camera, the position of the multi-task device relative to these marking elements or to detect an absence of normality of said single spindle in relation to said surface.

19. A method comprising:
performing a task by using a multi-task device comprising:
a frame;
a fastener for fastening said frame to a motorised handler able to move at least partially said device in space in relation to a structure to be worked;
a positioning/securing element for positioning and/or securing said device to said structure to be worked, a distance between said device and the surface of said structure to be worked being able to vary between an approach position and a docking position;
at least two functional modules, each of said functional modules comprising at least one movable member able to make it possible to perform a given task on said structure to be worked;
a single drive spindle movable in rotation and/or in translation along a same axis and able to cooperate individually with said movable members in order to drive said movable members in a rotation movement and/or translation movement allowing said movable members to perform their given task;
a camera having a depth of field, said camera being mounted movably between at least:
a stowage position wherein the camera does not extend in the axis of said single spindle;
an intermediate position wherein the camera extends in the axis of said single spindle;
said spindle being able to act on said camera so as to move the camera into at least one focussing position wherein said surface of said structure to be worked is situated in the depth of field of the camera;
wherein performing the task comprises moving said camera, by using said spindle, into at least one focussing position wherein said surface of said structure to be worked is situated in the field of depth of said camera.
